(19) United States
(12) Patent Application Publication
(10) Pub. No.: US 2026/0017969 A1
(43) Pub. Date: Jan. 15, 2026

(54) PREDICTION SELECTION FOR ITEM IDENTIFIERS USING EFFICIENT SELECTION ALGORITHM

(71) Applicant: Maplebear Inc., San Francisco, CA (US)

(72) Inventor: Mehdi Nikkhah, San Jose, CA (US)

(21) Appl. No.: 18/772,782

(22) Filed: Jul. 15, 2024

(51) Int. Cl. G06V 30/224; G06Q 20/20; G06Q 30/0601; G06V 30/194

(52) U.S. Cl. CPC G06V 30/2247; G06Q 20/208; G06Q 30/0635; G06V 30/194; G06V 2201/07

(57) ABSTRACT

A smart system, such as a smart shopping cart system, uses an efficient selection algorithm to select an item identifier prediction for an item. The smart cart system uses a set of machine-learning models to generate identifier predictions based on images. To select an item identifier, the smart system applies an efficient selection algorithm to the predictions from the machine-learning models. An efficient selection algorithm is an algorithm that requires minimal computational resources to perform. For example, the efficient selection algorithm may be a simple majority algorithm that selects the identifier prediction generated by a majority of the models or a weighted voting algorithm where each model's vote is weighted by some metric. The smart system applies the efficient selection algorithm to select an item identifier prediction from the ones generated by the models. The smart system may display content related to the item associated with the item identifier prediction.

### BACKGROUND

Many “smart” systems are existing appliances or items that have additional computing capabilities beyond their traditional counterparts. For example, a smart shopping cart can store items for a user but also includes an on-board computing system integrated with sensors coupled to the cart to identify items that the user adds to the cart. These smart systems generally have limited computational resources available to them, such as battery power, processor speed, data storage, or networking bandwidth. These limitations generally limit the applicability of machine-learning models to solve problems in the smart system context. For example, machine-learning models can require significant amounts of memory to store the parameters that are used to make inferences using those models, which can strain the data storage capacities of smart systems. This problem is exacerbated for systems using multiple machine-learning models, as each model typically requires significant amounts of memory and computational power to operate successfully.

### SUMMARY

A smart system, such as a smart shopping cart system, uses an efficient selection algorithm to select an item identifier prediction for an item. The smart cart system captures images of items and generates identifier predictions for the items based on the images. An identifier prediction is a prediction for an item identifier that identifies the item. The smart cart system uses a set of machine-learning models to generate identifier predictions. Each machine-learning model may generate its prediction independently, i.e., the prediction output by each machine-learning model is independent of the outputs of the other machine-learning models.

To select an item identifier, the smart system applies an efficient selection algorithm to the predictions from the machine-learning models. An efficient selection algorithm is an algorithm that requires minimal computational resources to perform. For example, the efficient selection algorithm may be a simple majority algorithm that selects the identifier prediction generated by a majority of the models or a weighted voting algorithm where each model's vote is weighted by some metric. The smart system applies the efficient selection algorithm to select an item identifier prediction from the ones generated by the models. The smart system may display content related to the item associated with the item identifier prediction.

By using an efficient selection algorithm, the smart system minimizes the computational resources used by the selection algorithm as compared to conventional techniques, such as a machine-learning model trained to select an item identifier prediction from those output by a set of models. By reducing the computational resource usage of the selection algorithm, more resources can be reserved for the machine-learning models themselves, thereby improving the overall performance of the smart cart system.

### BRIEF DESCRIPTION OF DRAWINGS

FIG. 1 illustrates an example system environment for a smart cart system, in accordance with one or more illustrative embodiments.

FIG. 2 is a flowchart for an example method of identifying an item by applying an efficient selection algorithm to predictions generated by multiple models, in accordance with some embodiments.

FIG. 3 illustrates an example data flow for applying a set of machine-learning models to an image, in accordance with some embodiments.

FIG. 4 illustrates an example application of an efficient selection algorithm to a set of item identifier predictions, in accordance with some embodiments.

### DETAILED DESCRIPTION

### Example System Environment for a Smart Cart System

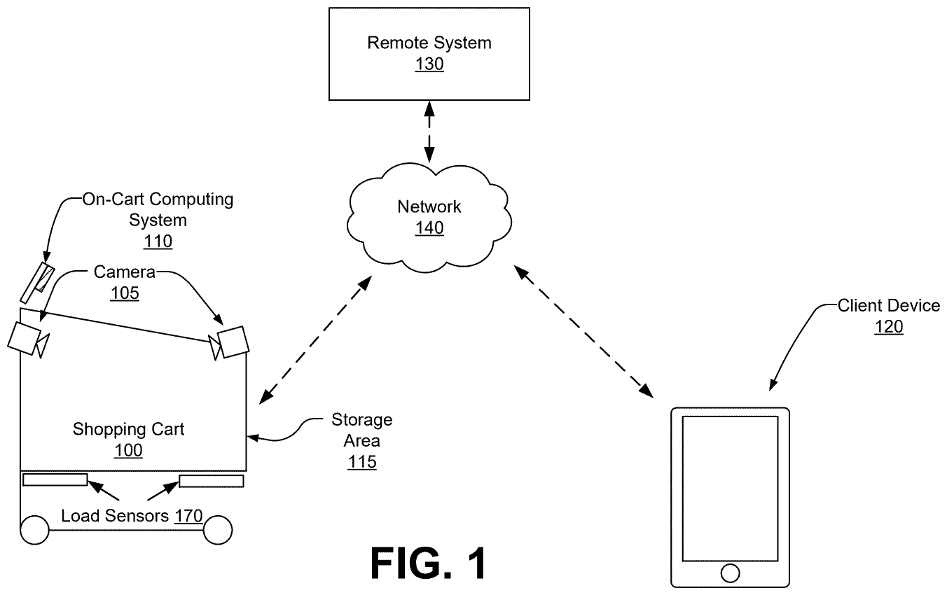

FIG. 1 illustrates an example system environment for a smart cart system, in accordance with one or more illustrative embodiments. The system environment illustrated in FIG. 1 includes a shopping cart 100, a client device 120, a remote system 130, and a network 140. Alternative embodiments may include more, fewer, or different components from those illustrated in FIG. 1, and the functionality of each component may be divided between the components differently from the description below. For example, functionality described below as being performed by the shopping cart may be performed, in some embodiments, by the remote system 130 or the client device 120. Similarly, functionality described below as being performed by the remote system 130 may, in some embodiments, be performed by the shopping cart 100 or the client device 120. Additionally, each component may perform their respective functionalities in response to a request from a human, or automatically without human intervention.

A shopping cart 100 is a vessel that a user can use to hold items as the user travels through a store. The shopping cart 100 includes one or more cameras 105 that capture image data of the shopping cart's storage area and a user interface that the user can use to interact with the shopping cart 100. The shopping cart 100 may include additional components not pictured in FIG. 1, such as processors, computer-readable media, power sources (e.g., batteries), network adapters, or sensors (e.g., load sensors, thermometers, proximity sensors).

The cameras 105 capture image data of the shopping cart's storage area. The cameras 105 may capture two-dimensional or three-dimensional images of the shopping cart's contents. The cameras 105 are coupled to the shopping cart 100 such that the cameras 105 capture image data of the storage area from different perspectives. Thus, items in the shopping cart 100 are less likely to be overlapping in all camera perspectives. In some embodiments, the cameras 105 include embedded processing capabilities to process image data captured by the cameras 105. For example, the cameras 105 may be mobile industry processor interface (MIPI) cameras. The cameras 105 may be set to capture images from the area surrounding the shopping cart including the user of the cart. In some embodiments, at least one of the cameras 105 is directed outward, away from the shopping cart 100.

In some embodiments, the shopping cart 100 captures image data in response to detecting that an item is being added to the storage area. The shopping cart 100 may detect that an item is being added to the storage area 115 of the shopping cart 100 based on sensor data from sensors on the shopping cart 100. For example, the shopping cart 100 may detect that a new item has been added when the shopping cart 100 (e.g., load sensors 170) detects a change in the overall weight of the contents of the storage area 115 based on load data from load sensors. Similarly, the shopping cart 100 may detect that a new item is being added based on proximity data from proximity sensors indicating that something is approaching the storage area of the shopping cart 100. The shopping cart 100 may capture image data within a timeframe near when the shopping cart 100 detects a new item. For example, the shopping cart 100 may activate the cameras 105 and store image data in response to detecting that an item is being added to the shopping cart 100 and for some period of time after that detection.

The shopping cart 100 may include one or more sensors that capture measurements describing the shopping cart 100, items in the shopping cart's storage area, or the area around the shopping cart 100. For example, the shopping cart 100 may include load sensors 170 that measure the weight of items placed in the shopping cart's storage area. Load sensors 170 are further described below. Similarly, the shopping cart 100 may include proximity sensors that capture measurements for detecting when an item is added to the shopping cart 100. The shopping cart 100 may transmit data from the one or more sensors to the remote system 130.

The one or more load sensors 170 capture load data for the shopping cart 100. In some embodiments, the one or more load sensors 170 may be scales that detect the weight (e.g., the load) of the content in the storage area 115 of the shopping cart 100. The load sensors 170 can also capture load curves—the load signal produced over time as an item is added to the cart or removed from the cart. The load sensors 170 may be attached to the shopping cart 100 in various locations to pick up different signals that may be related to items added at different positions of the storage area. For example, a shopping cart 100 may include a load sensor 170 at each of the four corners of the bottom of the storage area 115. In some embodiments, the load sensors 170 may record load data continuously while the shopping cart 100 is in use. In other embodiments, the shopping cart 100 may include some triggering mechanism, for example a light sensor, an accelerometer, or another sensor to determine that the user is about to add an item to the shopping cart 100 or about to remove an item from the shopping cart 100. The triggering mechanism causes the load sensors 170 to begin recording load data for some period of time, for example a preset time range.

The shopping cart 100 may include one or more wheel sensors (not shown) that measure wheel motion data of the one or more wheels. The wheel sensors may be coupled to one or more of the wheels on the shopping cart. In some embodiments, a shopping cart 100 includes at least two wheels (e.g., four wheels in the majority of shopping carts) with two wheel sensors coupled to two wheels. In further embodiments, the two wheels coupled to the wheel sensors can rotate about an axis parallel to the ground and can orient about an axis orthogonal or perpendicular to the ground. In other embodiments, each of the wheels on the shopping cart has a wheel sensor (e.g., four wheel sensors coupled to four wheels). The wheel motion data includes at least rotation of the one or more wheels (e.g., information specifying one or more attributes of the rotation of the one or more wheels). Rotation may be measured as a rotational position, rotational velocity, rotational acceleration, some other measure of rotation, or some combination thereof. Rotation for a wheel is generally measured along an axis parallel to the ground. The wheel rotation may further include orientation of the one or more wheels. Orientation may be measured as an angle along an axis orthogonal or perpendicular to the ground. For example, the wheels are at 0° when the shopping cart is moving straight and forward along an axis running through the front and the back of the shopping cart. Each wheel sensor may be a rotary encoder, a magnetometer with a magnet coupled to the wheel, an imaging device for capturing one or more features on the wheel, some other type of sensor capable of measuring wheel motion data, or some combination thereof.

The shopping cart 100 includes an on-cart computing system 110 that enables the user to perform an automated checkout through the shopping cart 100. The computing system includes a processor and a non-transitory computer-readable medium that stores instructions that may be executed by the processor. The computing system 110 also may include a display, a speaker, a microphone, a keypad, or a payment system (e.g., a credit card reader). The computing system 110 also includes a wireless network adapter that allows the computing system to communicate via the network 140.

The on-cart computing system 110 allows a customer at a brick-and-mortar store to complete a checkout process in which items are scanned and paid for without having to go through a human cashier at a point-of-sale station. The on-cart computing system 110 receives data describing a user's shopping trip in a store and generates a shopping list based on items that the user has selected. For example, the on-cart computing system 110 may receive data from cameras or sensors coupled to the shopping cart 100 and may determine, based on the data, which items the user has added to their cart.

The on-cart computing system 110 may use machine-learning models or computer-vision techniques to identify items that the user adds to the shopping cart. For example, the on-cart computing system 110 applies a barcode detection model to images captured by a camera of the shopping cart to identify items based on the barcodes that are visible to the camera. The barcode detection model is a machine-learning model (e.g., a neural network) that is trained to identify item identifiers that are encoded in barcodes that are depicted in image data. The barcode detection model may be trained based on a set of training examples. Each of the training examples may include an image of a barcode and a label that indicates what item identifier encoded by the barcode. In some embodiments, the on-cart computing system 110 preprocesses the image before applying the barcode detection model to the image. For example, the on-cart computing system may rotate the image so that the barcode is aligned with a set direction or may crop an image of an item to a portion of the image that depicts the barcode. U.S. patent application Ser. No. 17/703,076, entitled “Image-Based Barcode Decoding” and filed Mar. 24, 2022, describes an example barcode detection model in accordance with some embodiments and is incorporated by reference.

The on-cart computing system also may store and apply an optical character recognition (OCR) model to the image. An OCR model is a machine-learning model that converts typed, handwritten, or printed text depicted in images into machine-readable text. The on-cart computing system applies the OCR model to images captured by the cameras to identify items depicted in those images. For example, the on-cart computing system may generate a set of OCR text for an image. This OCR text is text that the OCR model has identified as being depicted in the image. The on-cart computing system uses the OCR text to identify items in images. For example, the on-cart computing system may apply another machine-learning model (e.g., a large language model) to the OCR text to predict which item is depicted in the image based on the OCR text.

In some embodiments, the on-cart computing system uses an item lookup table to identify items depicted in an image based on OCR text extracted from that image. The item lookup table stores a set of items that may be depicted in images captured by the cameras and corresponding text that is associated with each of the items. The on-cart computing system stores the item lookup table for use in identifying items. For example, the on-cart computing system may compare OCR text from an image to the corresponding text for each of the items to identify items depicted in images. The on-cart computing system may identify the item by identifying which item in the item lookup table has the most characters or words in common with the OCR text or which item has the longest sequence of characters in common with the OCR text. In some embodiments, rather than storing text in the item lookup table, the item lookup table stores embeddings that represent text associated with items. In these embodiments, the on-cart computing system may generate an embedding for OCR text and compare that embedding to the embeddings stored in the item lookup table to identify the item.

Furthermore, the on-cart computing system may store and apply an image embedding model to captured images to identify items. The image embedding model is a machine-learning model that is trained to generate embeddings for images captured by the cameras. The on-cart computing system applies the image embedding model to images captured by the cameras of the shopping cart and uses the embeddings to identify which items are depicted in the images. For example, the on-cart computing system may store embeddings that correspond to items that a user may place in the shopping cart. Each item may be associated with a single embedding or multiple embeddings. The on-cart computing system applies the image embedding model to images captured by the cameras and compares the generated embeddings to stored embeddings for items. The on-cart computing system identifies which item or items are depicted in an image based on how similar the generated embeddings are to the stored embeddings corresponding to the item(s). For example, the on-cart computing system may compute a distance, dot product, or cosine similarity between the embeddings to identify the item in the images. U.S. patent application Ser. No. 17/726,385, entitled “System for Item Recognition using Computer Vision” and filed Apr. 21, 2022, describes example methodologies for identifying items using a machine-learning model and is incorporated by reference.

Any of these models may be sensor fusion models that take sensor data as additional inputs. For example, a model may use weight data from a load sensor or proximity data from a proximity sensor as an additional input to predict an identifier for an item added to the shopping cart.

The on-cart computing system 110 generates a shopping list for the user as the user adds items to the shopping cart 100. The shopping list is a list of items that the user has gathered in the storage area 115 of the shopping cart 100 and intends to purchase. The shopping list may include identifiers for the items that the user has gathered (e.g., stock keeping units (SKUs)) and a quantity for each item. When the user indicates that they are done shopping at the store, the on-cart computing system 110 interfaces with the remote system 130 to facilitate a transaction between the user and the store for the user to purchase their selected items. For example, the on-cart computing system 110 may receive payment information from the user through a user interface and transmit that payment information to the remote system 130.

The user interface of the on-cart computing system 110 may allow the user to adjust the items in their shopping list or to provide payment information for a checkout process. Additionally, the user interface may display a map of the store indicating where items are located within the store. In some embodiments, a user may interact with the user interface to search for items within the store, and the user interface may provide a real-time navigation interface for the user to travel from their current location to an item within the store. The user interface also may display additional content to a user, such as suggested recipes or items for purchase. In some embodiments, the on-cart computing system 110 may receive content from the remote system 130 to display to the user. For example, the on-cart computing system may receive item recommendations, recipe recommendations, or brand recommendations from the remote system 130.

The on-cart computing system may include a tracking system configured to track a position, an orientation, movement, or some combination thereof of the shopping cart 100 in an indoor environment. The tracking system may further include other sensors capable of capturing data useful for determining position, orientation, movement, or some combination thereof of the shopping cart. Other example sensors include, but are not limited to, an accelerometer, a gyroscope, etc. The tracking system may provide real-time location of the shopping cart to an online system and/or database. The location of the shopping cart may inform content to be displayed by the user interface. For example, if the shopping cart 100 is located in one aisle, the display can provide navigational instructions to a user to navigate them to a product in the aisle. In other example use cases, the display can provide suggested products or items located in the aisle based on the user's location.

A user can also interact with the shopping cart 100 or the remote system 130 through a client device 120. The client device 120 can be a personal or mobile computing device, such as a smartphone, a tablet, a laptop computer, or desktop computer. In some embodiments, the client device 120 executes a client application that uses an application programming interface (API) to communicate with the remote system 130 through the network 140. The client device 120 may allow the user to add items to a shopping list and to checkout through the remote system 130. For example, the user may use the client device 120 to capture image data of items that the user is selecting for purchase, and the client device 120 may provide the image data to the remote system 130 to identify the items that the user is selecting. The client device 120 may adjust the user's shopping list based on the identified item. In some embodiments, the user can also manually adjust their shopping list through the client device 120.

In some embodiments, the on-cart computing system 110, the camera(s), and the sensors of the shopping cart are separately mounted to the shopping cart. Alternatively, the on-cart computing system 110, camera(s), and sensors may be contained within a single casing that is mounted to the shopping cart. This single casing may contain all of the components needed by the on-cart computing system 110 to perform the functionalities described herein. The single casing may be permanently mounted to the shopping cart or may be configured to be easily attached to or detached from the shopping cart. This latter embodiment may enable the on-cart computing system 110 to be recharged at a separate station from the shopping cart or may allow the computing system 110 to be easily mounted to pre-existing shopping carts, rather than requiring specially built shopping carts.

The shopping cart 100 and client device 120 can communicate with the remote system 130 via a network 140. The network 140 is a collection of computing devices that communicate via wired or wireless connections. The network 140 may include one or more local area networks (LANs) or one or more wide area networks (WANs). The network 140, as referred to herein, is an inclusive term that may refer to any or all of standard layers used to describe a physical or virtual network, such as the physical layer, the data link layer, the network layer, the transport layer, the session layer, the presentation layer, and the application layer. The network 140 may include physical media for communicating data from one computing device to another computing device, such as MPLS lines, fiber optic cables, cellular connections (e.g., 3G, 4G, or 5G spectra), or satellites. The network 140 also may use networking protocols, such as TCP/IP, HTTP, SSH, SMS, or FTP, to transmit data between computing devices. In some embodiments, the network 140 may include Bluetooth or near-field communication (NFC) technologies or protocols for local communications between computing devices. The network 140 may transmit encrypted or unencrypted data.

The remote system 130 communicates with the on-cart computing system 110 of the shopping cart to provide an automated checkout experience for the user. The remote system 130 may facilitate the user's payment for the items in the shopping cart. For example, the remote system 130 may receive the user's shopping list from the shopping cart and charge the user for the cost of the items in the cart. The remote system 130 may communicate with other systems to execute the transaction, such as a computing system of the retailer or of a financial institution. The remote system 130 may receive payment information from the shopping cart 100 and use that payment information to charge the user for the items. Alternatively, the remote system 130 may store payment information for the user in user data describing characteristics of the user. The remote system 130 may use the stored payment information as default payment information for the user and charge the user for the cost of the items based on that stored payment information.

In some embodiments, the remote system 130 establishes a session for a user to associate the user's actions with the shopping cart 100 to that user. The user may establish the session by inputting a user identifier (e.g., phone number, email address, username, etc.) into a user interface of the remote system 130. The user also may establish the session through the client device 120. The user may use a client application operating on the client device 120 to associate the shopping cart 100 with the client device 120. The user may establish the session by inputting a cart identifier for the shopping cart 100 through the client application, e.g., by manually typing an identifier or by scanning a barcode or QR code on the shopping cart 100 using the client device 120. In some embodiments, the remote system 130 establishes a session between a user and a shopping cart 100 automatically based on sensor data from the shopping cart 100 or the client device 120. For example, the remote system 130 may determine that the client device 120 and the shopping cart 100 are in proximity to one another for an extended period of time, and thus may determine that the user associated with the client device 120 is using the shopping cart 100.

The remote system 130 may also provide content to the on-cart computing system 110 to display to the user while the user is operating the shopping cart. For example, the remote system 130 may use stored user data associated with the user of the shopping cart to select content that the user is most likely to interact with. The remote system 130 may transmit that content to the on-cart computing system for display to the user. The remote system 130 may also provide other data to the on-cart computing system. For example, the remote system 130 may store item data describing items in the store and the remote system 130 may provide that item data to the on-cart computing system for the on-cart computing system to use to identify items.

In some embodiments, a user who interacts with the shopping cart 100 or the client device 120 may be an individual shopping for themselves or a shopper for an online concierge system. The shopper is a user who collects items from a store on behalf of a user of the online concierge system. For example, a user may submit a list of items that they would like to purchase. The online concierge system may transmit that list to a shopping cart 100 or a client device 120 used by a shopper. The shopper may use the shopping cart 100 or the client device 120 to add items to the user's shopping list. When the shopper has gathered the items that the user has requested, the shopper may perform a checkout process through the shopping cart 100 or client device 120 to charge the user for the items. U.S. Pat. No. 11,195,222, entitled “Determining Recommended Items for a Shopping List,” issued Dec. 7, 2021, describes online concierge systems in more detail, which is incorporated by reference herein in its entirety.

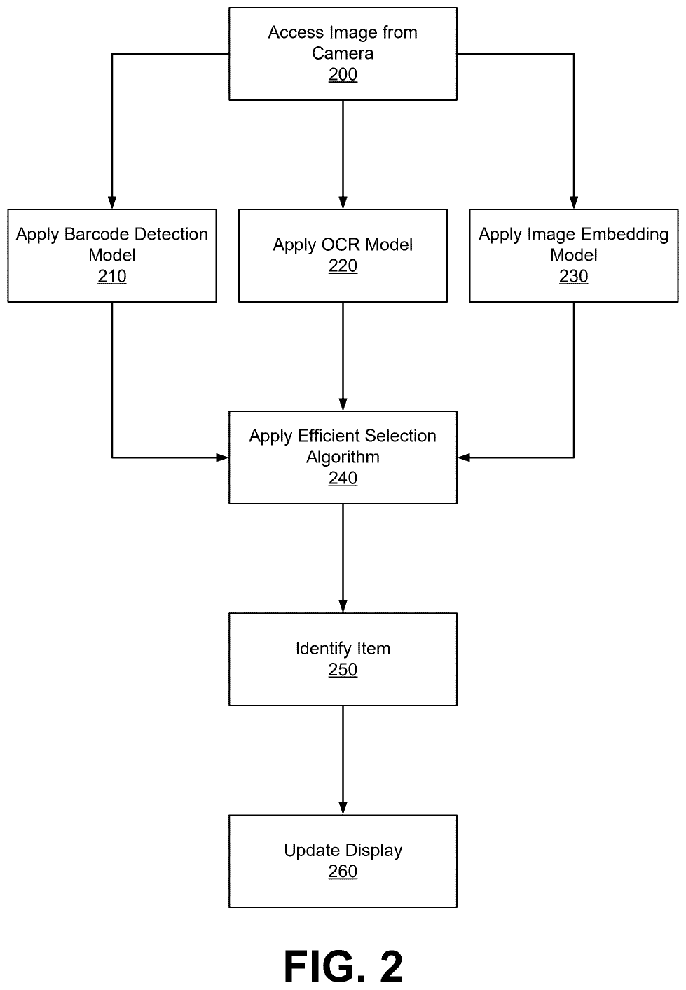

FIG. 2 is a flowchart for an example method of identifying an item by applying an efficient selection algorithm to predictions generated by multiple machine-learning models, in accordance with some embodiments. Alternative embodiments may include more, fewer, or different steps from those illustrated in FIG. 2 and the steps may be performed in a different order from that illustrated in FIG. 2. Furthermore, the steps of FIG. 2 are described as being performed by a computing system of a smart shopping cart. However, the steps may be performed individually or jointly by a smart shopping cart and a remote system.

The shopping cart accesses 200 an image captured by a camera coupled to the shopping cart. The image may depict an item located within a storage area of the shopping cart or may depict an item located nearby the shopping cart, depending on the orientation of the camera. In some embodiments, the shopping cart accesses multiple images captured by multiple cameras at approximately the same time. These multiple images may depict items in the storage area of the shopping cart from different angles. In some embodiments, the shopping cart also accesses sensor data captured at approximately the same time as the accessed image. For example, the shopping cart may access load data captured by a load sensor or proximity data captured by a proximity sensor.

The shopping cart applies three machine-learning models to the accessed image to generate three identifier predictions for the image. The shopping cart applies a barcode detection model 210, an optical character recognition (OCR) model 220, and an image embedding model 230 to the image to generate identifier predictions. These models are described in further detail above. These identifier predictions are predictions of item identifiers for items that a user may add to a shopping cart. For example, each item identifier may be a stock keeping unit code, a price lookup unit code, or an identifier maintained by an online system (e.g., an online concierge system) for identifying an item. In some embodiments, the machine-learning models also generate confidence scores for each corresponding item identifier. A confidence score represents a predicted likelihood that the corresponding identifier prediction is accurate.

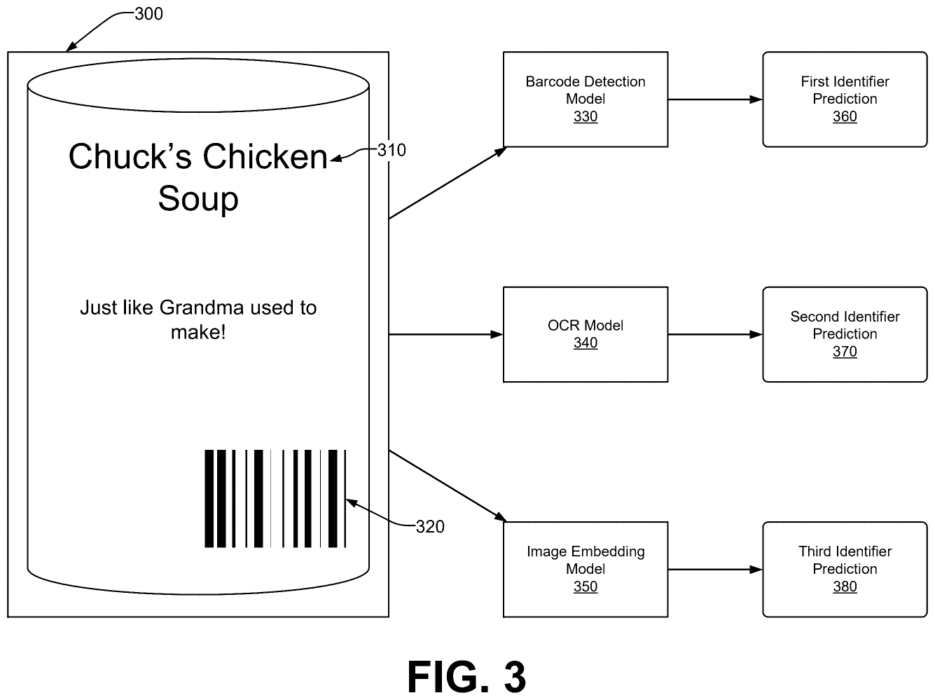

FIG. 3 illustrates an example data flow for applying a set of machine-learning models to an image, in accordance with some embodiments. The image 300 depicts an item, including text 310 on the item and a barcode 320 that are affixed to the item. The shopping cart applies the barcode detection model 330 to the image to generate a first identifier prediction 360, applies the OCR model 340 to the image to generate a second identifier prediction 370, and the image embedding model 350 to the image to generate a third identifier prediction 380.

The shopping cart applies 240 an efficient selection algorithm to select one of the identifier predictions to use for identifying the item depicted in the image. An efficient selection algorithm is an algorithm that requires minimal computational resources to perform. For example, the efficient selection algorithm may be a simple majority algorithm that selects the identifier prediction that is generated by a majority of the models (i.e., two out of three). Alternatively, the efficient selection algorithm may apply a weighted voting algorithm, where each model's “vote” for an identifier prediction is weighted by some metric. For example, each vote may be weighted based on a corresponding confidence score for the identifier prediction or based on a hierarchy of the machine-learning models. In some embodiments, the hierarchy prioritizes the models in the following order from highest priority to lowest priority: the barcode detection model, the OCR model, the image embedding model. In some embodiments, the efficient selection algorithm applies a linear regression to the identifier predictions from the machine-learning models to select one of the identifier predictions.

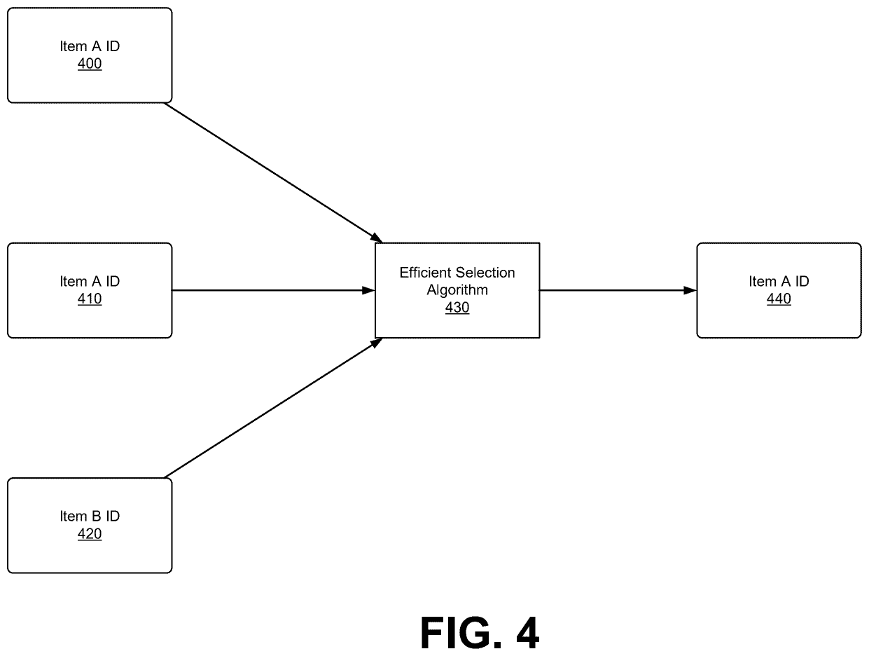

FIG. 4 illustrates an example application of an efficient selection algorithm 430 to a set of item identifier predictions. In FIG. 4, one model (e.g., the barcode detection model) generates an item identifier prediction 400 of Item A, another model (e.g., the OCR model) generates an item identifier prediction 410 of Item A, and a third model (e.g., the item embedding model) generates an item identifier prediction 420 of Item B. The efficient selection algorithm 430 selects one of the item identifiers 440 based on the predictions from each of the models, as described above.

The shopping cart identifies 250 the item depicted in the image based on the selected identifier prediction and adds the identified item to the user's shopping list. In some cases, the shopping cart may use a load sensor coupled to the shopping cart to weigh the identified item to determine a quantity of the item added to the shopping cart. The shopping cart updates 260 a display of the shopping cart to indicate that the item has been identified. The display may be updated to include the identified item in the user's shopping list.

While the description above primarily relates to using three specific machine-learning models, in alternative embodiments, the shopping cart may use more, fewer, or different machine-learning models from the specific examples provided above.

### Other Considerations

The foregoing description of the embodiments has been presented for the purpose of illustration; it is not intended to be exhaustive or to limit the scope of the disclosure. Many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some embodiments, a software module is implemented with a computer program product comprising one or more computer-readable media containing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The weights may be stored on one or more computer-readable media, and are used by a system when applying the machine-learning model to new data.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C having at least one element in the combination that is true (or present). As a not-limiting example, the condition “A, B, or C” is satisfied by A and B are true (or present) and C is false (or not present). Similarly, as another not-limiting example, the condition “A, B, or C” is satisfied by A is true (or present) and B and C are false (or not present).

What is claimed is:

1. A method comprising:
accessing, by a computing system coupled to a shopping cart, an image captured a camera of the shopping cart, wherein the image depicts an item;
generating a first identifier prediction for the item by applying a barcode detection model to the image, wherein the barcode detection model is a machine-learning model stored by the computing system of the shopping cart, and wherein the barcode detection model is trained to identify item identifiers that are encoded in barcodes depicted in images;
generating a second identifier prediction for the item by applying an optical character recognition model to the image, wherein the optical character recognition model is a machine-learning model stored by the computing system of the shopping cart, and wherein the optical character recognition model is a machine-learning model that is trained to generate machine-readable text that represents text depicted in an image;
generating a third identifier prediction for the item by applying an image embedding model to the image, wherein the image embedding model is a machine-learning model stored by the computing system of the shopping cart, and wherein the image embedding model is trained to generate embeddings representing images captured by the camera of the shopping cart;
identifying the item depicted in the image by selecting one of the first identifier prediction, the second identifier prediction, or the third identifier prediction, wherein the selecting comprises applying an efficient selection algorithm to the first identifier prediction, second identifier prediction, and third identifier prediction; and
updating a display on the shopping cart to indicate that the item has been identified.

2. The method of claim 1, wherein the image depicts the item stored in a storage area of the shopping cart.

3. The method of claim 1, wherein the first identifier prediction, the second identifier prediction, and the third identifier prediction are generated independently of each other.

4. The method of claim 1, wherein parameters for the barcode detection model, the optical character recognition model, and the image embedding model are stored in a memory of the computing system coupled to the shopping cart.

5. The method of claim 1, wherein applying the efficient selection algorithm comprises:
selecting one of the first identifier prediction, the second identifier prediction, or the third identifier prediction based on a simple majority algorithm.

6. The method of claim 1, wherein applying the efficient selection algorithm comprises:
selecting one of the first identifier prediction, the second identifier prediction, or the third identifier prediction based on a weighted voting algorithm.

7. The method of claim 6, wherein selecting one of the first of the first identifier prediction, the second identifier prediction, or the third identifier prediction comprises:
weighting the first identifier prediction, the second identifier prediction, and the third identifier prediction based on a corresponding confidence score generated by a corresponding model.

8. A non-transitory computer-readable medium storing instructions that, when executed by a processor, cause the processor to perform operations comprising:
accessing, by a computing system coupled to a shopping cart, an image captured a camera of the shopping cart, wherein the image depicts an item;
generating a first identifier prediction for the item by applying a barcode detection model to the image, wherein the barcode detection model is a machine-learning model stored by the computing system of the shopping cart, and wherein the barcode detection model is trained to identify item identifiers that are encoded in barcodes depicted in images;
generating a second identifier prediction for the item by applying an optical character recognition model to the image, wherein the optical character recognition model is a machine-learning model stored by the computing system of the shopping cart, and wherein the optical character recognition model is a machine-learning model that is trained to generate machine-readable text that represents text depicted in an image;
generating a third identifier prediction for the item by applying an image embedding model to the image, wherein the image embedding model is a machine-learning model stored by the computing system of the shopping cart, and wherein the image embedding model is trained to generate embeddings representing images captured by the camera of the shopping cart;
identifying the item depicted in the image by selecting one of the first identifier prediction, second identifier prediction, or third identifier prediction, wherein the selecting comprises applying an efficient selection algorithm to the first identifier prediction, second identifier prediction, and third identifier prediction; and
updating a display on the shopping cart to indicate that the item has been identified.

9. The non-transitory computer-readable medium of claim 8, wherein the image depicts the item stored in a storage area of the shopping cart.

10. The non-transitory computer-readable medium of claim 8, wherein the first identifier prediction, the second identifier prediction, and the third identifier prediction are generated independently of each other.

11. The non-transitory computer-readable medium of claim 8, wherein parameters for the barcode detection model, the optical character recognition model, and the image embedding model are stored in a memory of the computing system coupled to the shopping cart.

12. The non-transitory computer-readable medium of claim 8, wherein applying the efficient selection algorithm comprises:
selecting one of the first identifier prediction, the second identifier prediction, or the third identifier prediction based on a simple majority algorithm.

13. The non-transitory computer-readable medium of claim 8, wherein applying the efficient selection algorithm comprises:
selecting one of the first identifier prediction, the second identifier prediction, or the third identifier prediction based on a weighted voting algorithm.

14. The non-transitory computer-readable medium of claim 13, wherein selecting one of the first of the first identifier prediction, the second identifier prediction, or the third identifier prediction comprises:
weighting the first identifier prediction, the second identifier prediction, and the third identifier prediction based on a corresponding confidence score generated by a corresponding model.

15. A system comprising:
a processor; and
a non-transitory computer-readable medium storing instructions that, when executed by the processor, cause the processor to perform operations comprising:
accessing, by a computing system coupled to a shopping cart, an image captured a camera of the shopping cart, wherein the image depicts an item;
generating a first identifier prediction for the item by applying a barcode detection model to the image, wherein the barcode detection model is a machine-learning model stored by the computing system of the shopping cart, and wherein the barcode detection model is trained to identify item identifiers that are encoded in barcodes depicted in images;
generating a second identifier prediction for the item by applying an optical character recognition model to the image, wherein the optical character recognition model is a machine-learning model stored by the computing system of the shopping cart, and wherein the optical character recognition model is a machine-learning model that is trained to generate machine-readable text that represents text depicted in an image;
generating a third identifier prediction for the item by applying an image embedding model to the image, wherein the image embedding model is a machine-learning model stored by the computing system of the shopping cart, and wherein the image embedding model is trained to generate embeddings representing images captured by the camera of the shopping cart;
identifying the item depicted in the image by selecting one of the first identifier prediction, second identifier prediction, or third identifier prediction, wherein the selecting comprises applying an efficient selection algorithm to the first identifier prediction, second identifier prediction, and third identifier prediction; and
updating a display on the shopping cart to indicate that the item has been identified.

16. The method of claim 1, wherein the image depicts the item stored in a storage area of the shopping cart.

17. The method of claim 1, wherein the first identifier prediction, the second identifier prediction, and the third identifier prediction are generated independently of each other.

18. The method of claim 1, wherein parameters for the barcode detection model, the optical character recognition model, and the image embedding model are stored in a memory of the computing system coupled to the shopping cart.

19. The method of claim 1, wherein applying the efficient selection algorithm comprises:
selecting one of the first identifier prediction, the second identifier prediction, or the third identifier prediction based on a simple majority algorithm.

20. The method of claim 1, wherein applying the efficient selection algorithm comprises:
selecting one of the first identifier prediction, the second identifier prediction, or the third identifier prediction based on a weighted voting algorithm.
